(19) United States
(12) Patent Application Publication
(10) Pub. No.: US 2007/0039779 A1
(43) Pub. Date: Feb. 22, 2007

(54) Hunting stand

(76) Inventor: Loren Ellingson, (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/208,401

(22) Filed: Aug. 18, 2005

(51) Int. Cl. E06C 7/16

(52) U.S. Cl. 182/115

(57) ABSTRACT

An improved hunting stand has been developed that includes a seat with a fixed gun rest. The seat and gun rest a capable of rotating together to face a different direction. The stand also includes adjustable leg assemblies that allow the stand to provide the hunter a level hunting platform when the stand is located on uneven ground.

### BACKGROUND OF INVENTION

1. Field of the Invention

The invention relates generally to hunting equipment. More specifically, the invention relates to an improved hunting stand that has legs that are independently adjustable.

2. Background Art

Hunting stands are commonly used by hunters to provide an elevated platform for observing game such as deer. A hunting stand also helps prevent the hunter from being spotted by the game since most animals are focused on detecting threats on the ground. However, hunting stands have several limitations. In order to provide a level platform for the hunter, the hunting stand is restricted to flat ground. Unfortunately, this limits the areas of land used by the hunter. Additionally, most hunting stands have a fixed seat with a support for the hunter's gun. This arrangement limits the flexibility of the stand because the user is limited to facing in one direction. Consequently, a hunting stand is needed that has adjustable legs so that it can be used in all different types of terrain while still providing a level platform for the hunter. Additionally, it would be advantageous for a hunting stand to have a seat with a gun support that is capable of rotating to provide the hunter with the ability to change directions while in the stand.

### SUMMARY OF INVENTION

In some aspects, the invention relates to a hunting stand, comprising: a seating apparatus comprising a seat and a gun rest; and a support apparatus that is attached to the seating apparatus with a rotating mechanism so that the seating apparatus may rotate to face multiple directions.

In other aspects, the invention relates to a hunting stand, comprising: a seat; a support apparatus that is attached to the seat comprising, a plurality of adjustable legs that provide a level platform for the seat, and a ladder that allows access to the seat.

In other aspects, the invention relates to a hunting stand, comprising: a seating apparatus comprising a seat with a gun rest that is connected to the seat with a mount; a support apparatus comprising, two independently adjustable leg assemblies that are connected together with stabilizing cross braces, where a ladder is integral to one of the leg assemblies, two lateral supports that laterally stabilizes the support apparatus, and a ladder that allows access to the seating apparatus; and a rotating attachment mechanism that connects the seating apparatus to the support apparatus so that the seating apparatus may rotate 360 degrees.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a perspective view of an improved hunting stand in accordance with one embodiment of the present invention.

FIGS. 2A and 2B show a front and side view respectively of an improved hunting stand in accordance with one embodiment of the present invention.

FIG. 3 shows an exploded view of the seating apparatus in accordance with one embodiment of the present invention.

FIG. 4 shows a perspective view of the support apparatus in accordance with one embodiment of the present invention.

FIG. 5A shows a perspective view of the base of the ladder for the support apparatus in accordance with one embodiment of the present invention.

FIG. 5B shows a view of an adjustable leg for the support apparatus in accordance with one embodiment of the present invention.

### DETAILED DESCRIPTION

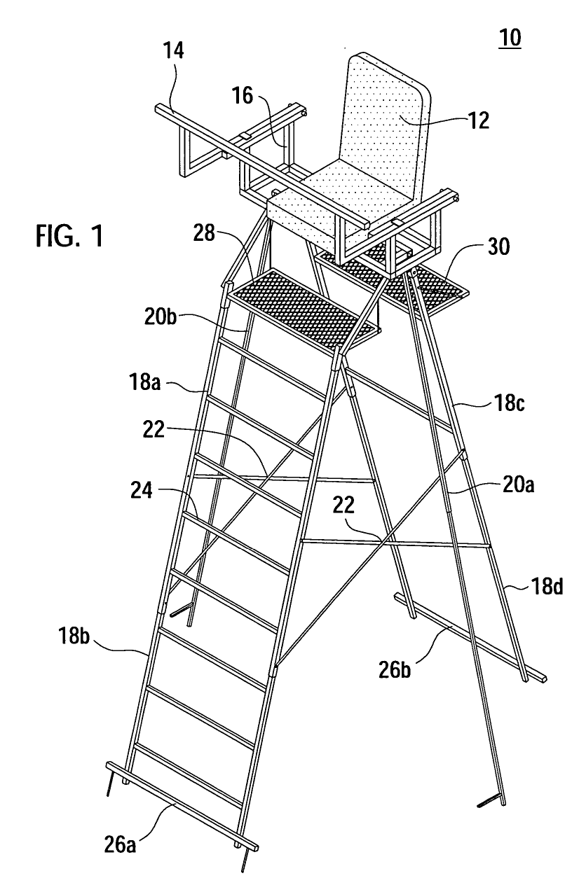

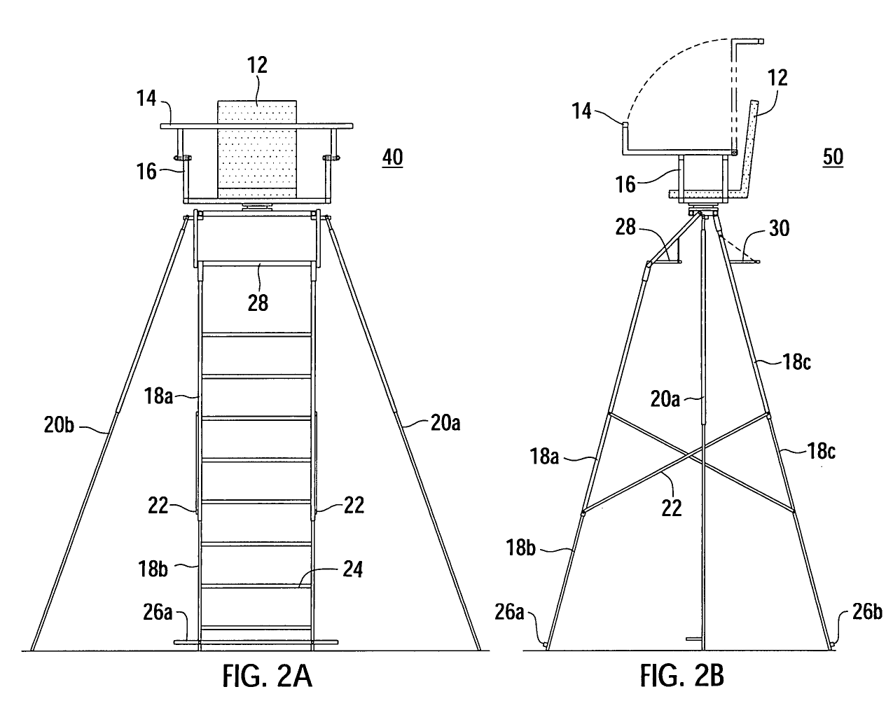

The present invention is a hunting stand that has individually adjustable legs that may be extended or retracted for placement on uneven ground. FIG. 1 shows a perspective view of an improved hunting stand 10 in accordance with one embodiment of the present invention. The stand 10 includes a seat 12 and footrest 28 for the hunter. A gun rest 14 is located in front of the seat 12 to allow the hunter to take a steady aim. The gun rest 14 is attached to the seat with a mount 16. As shown in FIG. 2B, the gun rest 14 is attached to the mount 16 with a pivoting joint that allows the gun rest 14 to be raised and lowered to allow the hunter into the seat 12. The stand 10 is supported by two independently adjustable leg assemblies 18a-18d and two lateral supports 20a and 20b. Cross braces 22a and 22b provide additional stability to the leg assemblies 18a-18d. A ladder 24 that is integrated into the front leg assembly 18a and 18b is used to climb the stand 10. A pair of ground braces 26a and 26b is used to stabilize both the front leg assembly 18a and 18b as well as the rear leg assembly 18c and 18d. FIGS. 2A and 2B show a front 40 and side 50 views respectively of the stand.

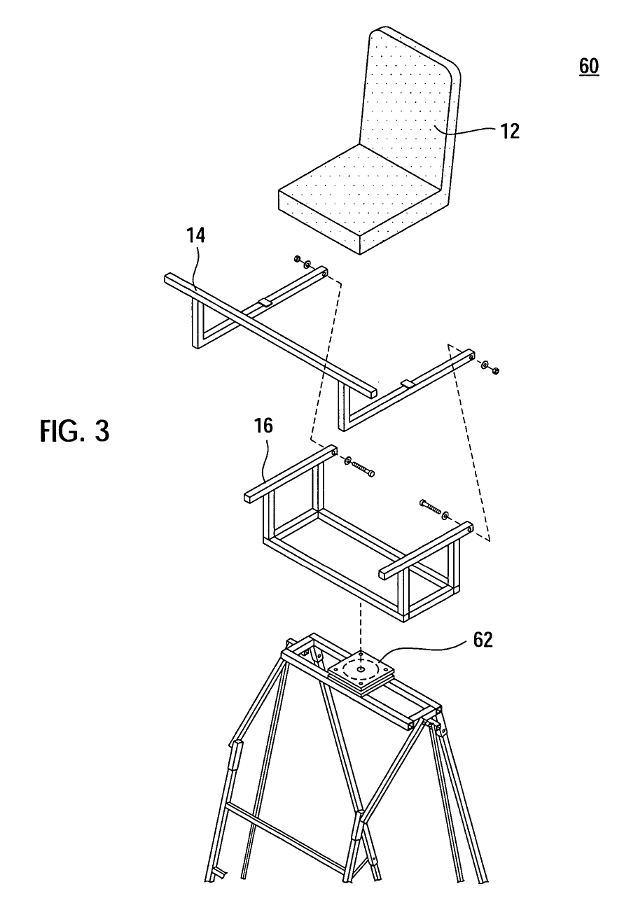

FIG. 3 shows an exploded view of the seating apparatus 60 for one embodiment of the hunting stand. The term “seating apparatus” includes: a seat 12; a gun rest 14; a gun mount 16; and a rotating attachment mechanism 62. The seat 12 and the gun mount 16 are fixed to each other so that the gun rest 14 is always directly in front of the seat 12. They are then mounted on the rotating attachment mechanism 62 that allows the seat/rest/mount to rotate 360 degrees in either direction as a single piece. A key advantage of the present invention is the ability to rotate the entire seating apparatus that includes the seat and gun rest to face whatever direction is desired. For example, the hunter may completely reverse his direction after climbing the ladder and utilize the rear foot rest 30 as shown in FIG. 1.

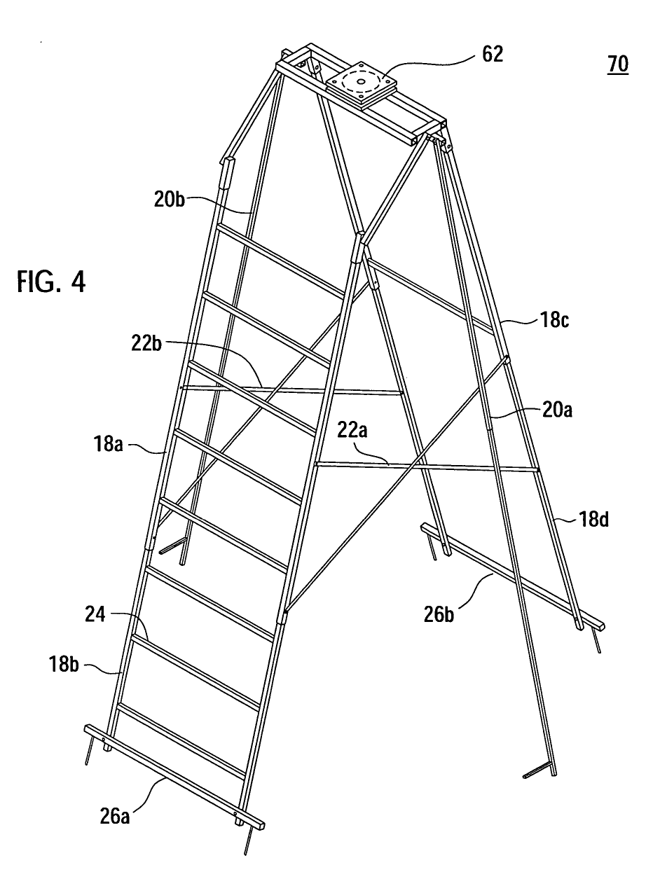

FIG. 4 shows a perspective view of the support apparatus 70 for one embodiment of the hunting stand. The term “support apparatus” includes: a front adjustable leg assembly 18a-18b with an integrated ladder 24; a rear adjustable leg assembly 18c-18d; lateral leg supports 20a and 20b; and cross braces 22a and 22b. The rotating attachment mechanism 62 for the seating apparatus is mounted on top of the support apparatus 70. A key advantage of the present invention is the separate adjustability of each leg assembly 18a-18d and lateral leg support 20a and 20b. This allows the stand to be place in a wide variety of terrain while still providing a level platform for the seating apparatus.

In one embodiment, the leg assemblies and lateral supports are adjustable with a “telescoping” arrangement where an extendible part of the leg slides inside a hollow portion of the non-extendible part of the leg. Once the desired length is reached, the extendible part of the leg is fixed in place with screw, cotter pin or other similar holding mechanism. FIG. 4 shows the upper or “female” segments 18a and 18c of the leg assemblies and the lower or “male” segments 18b and 18d of the leg assemblies. In the embodiment shown, the lower segments 18b and 18d will slide into the upper segments 18a and 18c until the desired length is reached for each respective assembly. The lower segments 18b and 18d will then be locked into position by the holding mechanism (not shown). In some embodiments, the individual legs of the ladder 24 will be removable to allow the lower segment 18b to move farther up into the upper segment 18a.

By way of example, the stand could be placed up against the base of a steep hill. The rear leg assembly 18c and 18d would be shorten and anchored in the hillside with the rear ground brace 26b. The front leg assembly 18a and 18b will be extended to their normal length and the lateral leg supports 20a and 20b will be extended out accordingly. Finally, the cross braces 22a and 22b will be attached to points on the extended front leg assembly and retracted rear leg assembly. When completely set up, the rotating attachment mechanism 62 will provide a flat and level platform for the seating apparatus 60.

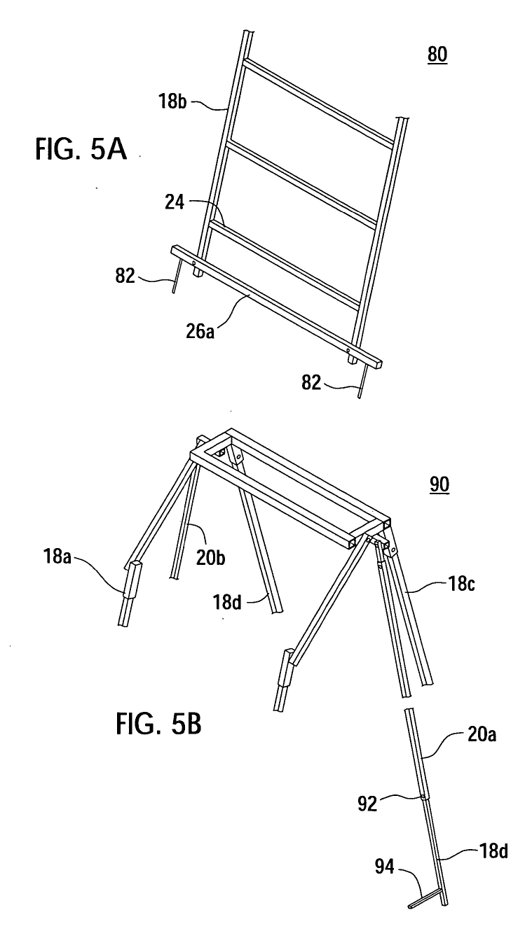

FIG. 5A and shows a detailed view 82 of the base of the ladder 24 with a ground brace 26 for the support apparatus. In the embodiment shown, the ground brace 26 extends beyond the front leg assembly 18a and 18b of the ladder 26 in order to better distribute the weight load of the stand. Additional stability is provided by ground spikes 82 attached to the brace 26. The spikes 82 are pushed into the ground to help prevent any shifting of the ladder once it is in place.

FIG. 5B shows a view 90 of a lateral leg support 20a for the support apparatus in accordance with one embodiment of the present invention. In the embodiment shown, the support 20a is adjustable with a telescoping mechanism 92. Also shown, is a lateral brace 94 that helps distribute the weight load of the stand.

While one example of the present invention has been shown in FIGS. 1-5B, it should be clear that many variations of the present invention are possible by varying the number and location of such features as the leg assemblies, lateral supports, and cross braces. Additionally, it should be understood that the stand could be collapsible for easy transportation to and from the installation location.

Consequently, the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A hunting stand, comprising:
a seating apparatus comprising a seat and a gun rest; and
a support apparatus that is attached to the seating apparatus with a rotating mechanism so that the seating apparatus may rotate to face multiple directions.

2. The hunting stand of claim 1, where the gun rest in attached to the seat with a gun rest mount.

3. The hunting stand of claim 1, where the seating apparatus may rotate 360 degrees.

4. The hunting stand of claim 1, where the support apparatus comprises a plurality of foot rests located below the seat.

5. A hunting stand, comprising:
a seat;
a support apparatus that is attached to the seat comprising,
a plurality of adjustable legs that provide a level platform for the seat, and
a ladder that allows access to the seat.

6. The hunting stand of claim 5, where the adjustable legs are adjusted with a telescoping mechanism.

7. The hunting stand of claim 5, further comprising a plurality of lateral support legs that provide lateral support for the seat.

8. The hunting stand of claim 7, where the lateral support legs are adjustable with a telescoping mechanism.

9. The hunting stand of claim 5, further comprising at least one of cross brace that connects the adjustable legs in order to provide additional stability to the support apparatus.

10. A hunting stand, comprising:
a seating apparatus comprising a seat with a gun rest that is connected to the seat with a mount;
a support apparatus comprising,
two independently adjustable leg assemblies that are connected together with stabilizing cross braces, where a ladder is integral to one of the leg assemblies,
two lateral supports that laterally stabilizes the support apparatus, and
a ladder that allows access to the seating apparatus; and
a rotating attachment mechanism that connects the seating apparatus to the support apparatus so that the seating apparatus may rotate 360 degrees.
